(19) United States
(12) Patent Application Publication
(10) Pub. No.: US 2009/0077656 A1
(43) Pub. Date: Mar. 19, 2009

(54) IMAGE FORMING APPARATUS, IMAGE FORMING SYSTEM, AND CONTROL METHOD OF IMAGE FORMING APPARATUS

(75) Inventors: Yuya Oka, Mishima-shi (JP); Fumiyoshi Kittaka, Yokohama-shi (JP); Yasukazu Kobayashi, Sunto-gun (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/855,481

(22) Filed: Sep. 14, 2007

(51) Int. Cl. H04L 9/32

(52) U.S. Cl. 726/21

(57) ABSTRACT

An image forming apparatus according to the present invention is an image forming apparatus capable of playing plural roles alone, the image forming apparatus including an authentication database in which association between a user and authentication information of the user is registered, a role management database in which association between the user and the role allocated to the user, association between a department to which a plurality of users belong and the role allocated to the department, and association between the user and the department to which the user belongs are registered, an authenticating unit that performs authentication of the user according to matching between authentication information inputted by the user and the authentication information registered in the authentication database, and a role managing unit that permits, with reference to the role management database, the user authenticated by the authenticating unit to use the role allocated to the user and permits the department to which the user authenticated by the authenticating unit belongs to use the role allocated to the department.

### BACKGROUND OF THE INVENTION

1. Field of the Invention

The present invention relates to an image forming apparatus, an image forming system, and a control method of the image forming apparatus, and, more particularly to an image forming apparatus such as an MFP (Multi-Function Peripheral), an image forming system in which image forming apparatuses such as MFPs (Multi-Function Peripherals) and a server are connected through a network, and a control method of the image forming apparatus.

2. Description of the Related Art

As a form of an image forming apparatus, there is an apparatus called an MFP (Multi-Function Peripheral). The MFP is a digital complex machine that realizes plural functions such as a scanner function, a facsimile function, and an image data saving function in addition to a copying function and plays roles of plural apparatuses alone.

On the other hand, among MFPs, there has been an MFP that has a management function called a role management function. The role management function is a function of limiting plural functions, i.e., plural roles of the MFP depending on a user of the MFP.

For example, it is assumed that the MFP has a role (a) as a copying machine, a role (b) as a scanner, a role (c) as a facsimile apparatus, and a role (d) as an image data saving apparatus.

When the MFP has these roles, the MFP permits a user A to use the role (a) and the role (c) and prohibits the user A from using the role (b) and the role (d). On the other hand, the MFP permits another user B to use the role (a), the role (b), and the role (d) and prohibits the user B from using the role (c). Such a management function is called the role management function.

As the image data saving apparatus included in the MFP, there is an image data saving apparatus, a recording area of which is sectioned into plural recording areas called boxes (e.g., n boxes from a box 1 to a box n). In this case, the role (d) for the image data saving function can be subdivided into roles from a role (d1) to a role (dn) that use the boxes 1 to n, respectively. Therefore, more careful management is performed by the role management function.

The MFP having the role management function holds a role management database in which users and roles allocated to the users (i.e., roles that the users are permitted to use) are registered, respectively and associated with each other.

When the role management function is effective, first, a user performs user authentication. When the user is authenticated as a registered user as a result of the user authentication, the role management database is referred to and the user can use a role registered in association with the user.

In some cases, user authentication and role management functions are performed on the outside of the MFP. For example, in an image forming system in which a server having a user authentication function and a role management function and MFPs are connected through a network, the server performs user authentication and role management.

When the role management for the MFP is performed, it may be unnecessary to perform role management in an individual user unit. It may be sufficient to perform role management in a unit of a department including plural users. This role management is often more convenient. An example of this role management is role management for allocating the role (a) and the role (d1) to all members in a technical department A and allocating the role (c) and the role (d2) to all members in an accounting department B.

However, the role management in the past is solely performed in user units and is not applicable to role management in department units. Therefore, when it is attempted to allocate the role (a) and the role (d1) to the technical department A, it is necessary to correct the role management database to allocate the role (a) and the role (d1) to all users belonging to the technical department A. This work is extremely complicated for an administrator of the role management database. Naturally, highly flexible role management in which the role management in user units and the role management in department units are combined cannot be performed.

### SUMMARY OF THE INVENTION

The present invention has been devised in view of the circumstances and it is an object of the present invention to provide an image forming apparatus capable of playing plural roles alone and an image forming system including the image forming apparatus, wherein not only role management in user units but also role management in department units for a department including plural users can be performed, and a control method of the image forming apparatus.

In order to attain the object, an image forming apparatus according to an aspect of the present invention is an image forming apparatus capable of playing plural roles alone, the image forming apparatus including an authentication database in which association between a user and authentication information of the user is registered, a role management database in which association between the user and the role allocated to the user, association between a department to which a plurality of the users belong and the role allocated to the department, and association between the user and the department to which the user belongs are registered, respectively, an authenticating unit that performs authentication of the user according to matching between authentication information inputted by the user and the authentication information registered in the authentication database, and a role managing unit that permits, with reference to the role management database, the user authenticated by the authenticating unit to use the role allocated to the user and permits the department to which the user authenticated by the authenticating unit belongs to use the role allocated to the department.

In order to attain the object, an image forming system according to another aspect of the present invention is an image forming system including an image forming apparatus capable of playing plural roles alone and a server connected to the image forming apparatus through a network, wherein the server includes an external authentication database in which association between a user and authentication information of the user is registered and an external role management database in which association between the user and the role allocated to the user and association between a department to which a plurality of the users belong and the role allocated to the department are registered, respectively and the image forming apparatus includes an authenticating unit that performs authentication of the user with reference to the external authentication database and a role managing unit that permits, with reference to the external role management database, the user authenticated by the authenticating unit to use the role allocated to the user and permits the department to which the user authenticated by the authenticating unit belongs to use the role allocated to the department.

In order to attain the object, a control method of an image forming apparatus according to still another aspect of the present invention is a control method of an image forming apparatus capable of playing plural roles alone, the control method including the steps of (a) registering association between a user and authentication information of the user in an authentication database, (b) registering association between the user and the role allocated to the user and association between a department to which a plurality of the users belong and the role allocated to the department, and association between the user and the department to which the user belongs in a role management database, respectively, (c) performing authentication of the user with reference to the authentication database, and (d) performing role management for permitting, with reference to the role management database, the authenticated user to use the role allocated to the user and permitting the department to which the authenticated user belongs to use the role allocated to the department.

### BRIEF DESCRIPTION OF THE DRAWINGS

In the accompanying drawings:

FIG. 1 is a diagram showing an example of the structure of an image forming apparatus and an image forming system according to an embodiment of the present invention;

FIG. 2 is a diagram schematically showing a relation between users and departments in the embodiment;

FIG. 3 is a diagram showing an example of the structure of a database included in the image forming apparatus;

FIG. 4 is a diagram showing an example of the structure of a database included in a server;

FIG. 5 is a flowchart showing an example of processing concerning role management;

FIG. 6 is a diagram showing a display example of a control panel during user authentication;

FIG. 7 is a diagram showing a display example of the control panel during setting of a role management method;

FIG. 8 is a diagram for explaining an example of a method of acquiring a user role in an internal mode;

FIG. 9 is a diagram for explaining an example of a method of acquiring a user role in an external mode;

FIG. 10 is a diagram for explaining an example of a method of acquiring a department role in the internal mode;

FIG. 11 is a diagram for explaining an example of a method of acquiring a department role in the external mode;

FIG. 12 is a diagram for explaining an example of a method of acquiring a department role and a user role in the internal mode; and

FIG. 13 is a diagram for explaining an example of a method of acquiring a department role and a user role in the external mode.

### DETAILED DESCRIPTION OF THE INVENTION

Embodiments of an image forming system and a control method thereof according to the present invention will be hereinafter explained in detail with reference to the accompanying drawings.

### (1) Structure of an Image Forming Apparatus and an Image Forming System

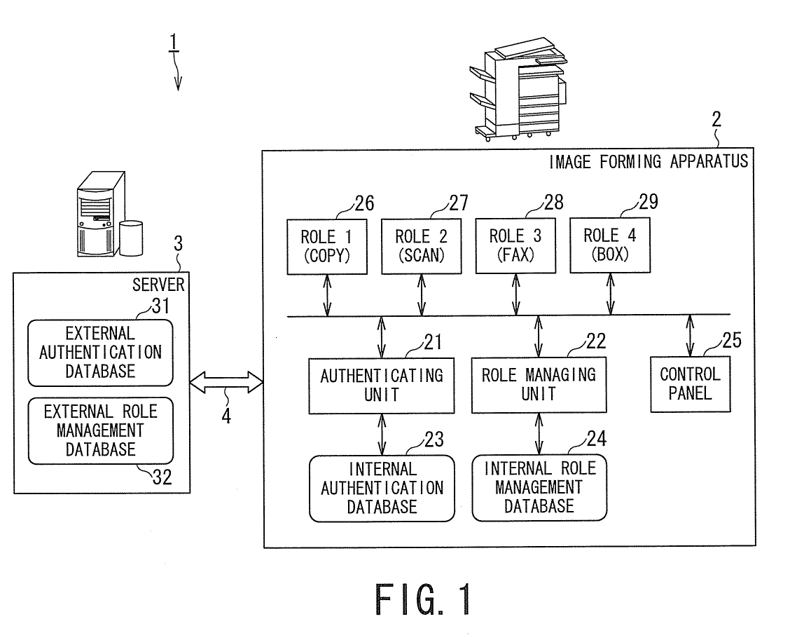

FIG. 1 is a diagram showing an example of the structure of an image forming system 1 and an image forming apparatus 2 according to an embodiment of the present invention.

The image forming system 1 includes the image forming apparatus 2 and a server 3, which are connected through a network 4.

The image forming apparatus 2 is a digital complex machine called an MFP. The image forming apparatus 2 is capable of playing roles of plural apparatuses such as a copying machine, a scanner, a facsimile apparatus, and an image data recording apparatus (a BOX apparatus) alone.

In FIG. 1, as an example of the roles of the plural apparatuses, the role as the copying machine is shown as a role (1) 26, the role as the scanner is shown as a role (2) 27, the role as the facsimile apparatus is shown as a role (3) 28, and the role as the BOX apparatus is shown as a role (4) 29.

The image forming apparatus 2 includes an authenticating unit 21, a role managing unit 22, an internal authentication database 23, an internal role management database 24, and a control panel 25.

The authenticating unit 21 performs user authentication according to matching between authentication information inputted from the control panel 25 by a user and authentication information registered in the internal authentication database 23.

A specific method of the user authentication is not specifically limited. The user authentication is, for example, an authentication by a password, biometric authentication such as fingerprint authentication, and token authentication by an IC card.

The role managing unit 22 performs role management on the basis of data registered in the internal role management database 24. In the internal role management database 24, roles allocated to each user and each department are registered in advance. The role managing unit 22 permits the user and the department to use only the allocated roles. More detailed operations are described later.

On the other hand, an external authentication database 31 and an external role management database 32 similar to the internal authentication database 23 and the internal role management database 24 are provided in the server 3.

The image forming apparatus 2 has an internal mode and an external mode, which can be selected by the user.

When the internal mode is selected, user authentication is performed on the basis of the internal authentication database 23 of the image forming apparatus 2 and, while role management is performed on the basis of the internal role management database 24.

On the other hand, when the external mode is selected, user authentication is performed on the basis of the external authentication database 31 of the server 3 and, while role management is performed mainly on the basis of the external role management database 32.

The image forming apparatus 2 may have only one of the internal mode and the external mode. When the image forming apparatus 2 has only the internal mode, the image forming apparatus 2 independently operates. Only the internal authentication database 23 and the internal role management database 24 are referred to.

When the image forming apparatus 2 has only the external mode, the internal authentication database 23 and the internal management database 24 are unnecessary. In this case, only the external authentication database 31 and the external role management database 32 of the server 3 are referred to.

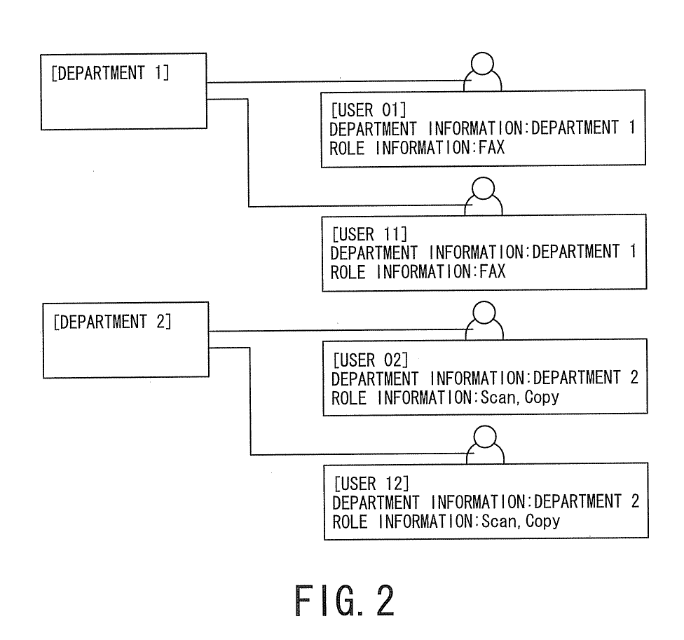

FIG. 2 is a diagram schematically showing a relation between users (here, the users indicate individual users) who use the image forming system 1 or the image forming apparatus 2 and departments to which the users belong. For example, a “user 01” and a “user 11” belong to a “department 1”. A “user 02” and a “user 12” belong to a “department 2”.

In the role management in the past, only role management in user units is performed and role management in department units is not performed. In an example in FIG. 2, only FAX is allocated to the “user 01” and the “user 11” as a role. When it is attempted to allocate a role of COPY anew to all members belonging to the “department 1”, in the past, it is necessary to update role management data of the respective members belonging to the “department 1”.

In this embodiment, since a function of collectively performing role management in department units is provided, the inconvenience in the past is eliminated.

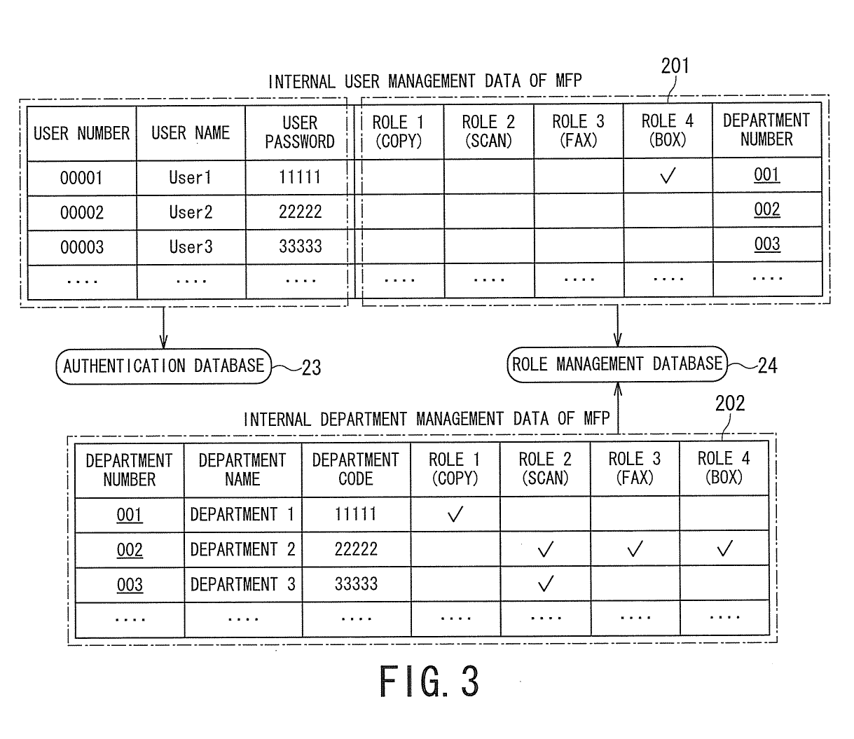

FIG. 3 is a diagram showing, in a form of a table, an example of the structure of the internal authentication database 23 and the internal role management database 24 of the image forming apparatus 2. A database for user authentication and a database for role management do not always have to be independently provided and may be formed as an integrated database obtained by combining both the databases or may be a database sectioned in user units and department units. In the example shown in FIG. 3, the authentication database 23 for user authentication and the role management database 24 in user units are combined as an internal user management data 201. The role management database 24 in department units is formed as internal department management data 202.

In the internal user management data 201, association between a user represented by a “user number”, a “user name”, and the like and a “user password” as authentication information is registered. Association between the user and roles allocated to the user is also registered. A check-mark in the table indicates that a role is allocated and a blank in the table indicates that a role is not allocated. This applies in the following examples. In an example of the internal user management data 201 in FIG. 3, only a role (4) is allocated to a “User 1” and a role (1), a role (2), and a role (3) are not allocated to the “User 1”. No role is allocated to a “User 2” and a “User 3”.

On the other hand, in the internal department management data 202, association between a department represented by a “department number”, a “department name”, a “department code”, and the like and roles allocated to the department is registered. In an example of the internal department management data 202 in FIG. 3, the role (1) is allocated to a “department 1”, the role (2), the role (3), and the role (4) are allocated to a “department 2”, and the role (2) is allocated to a “department 3”.

In both the internal user management data 201 and the internal department management data 202, the “department number” is provided as common data. The user and the department are associated by the data of the “department number”.

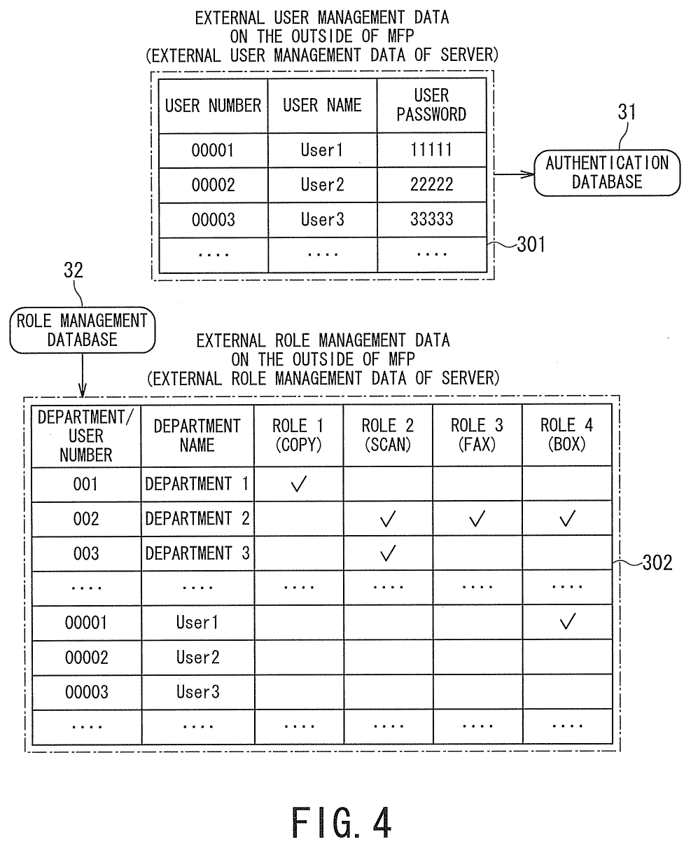

FIG. 4 is a diagram showing an example of the structure of the external authentication database 31 and the external role management database 32 provided in the server 3.

The external authentication database 31 is formed as external user management data 301 and is a database exclusively used for user authentication.

The external role management database 32 is formed as external role management data 302 and is a database exclusively used for role management. In the external role management data 302, a data area indicating allocation of roles in department units and a data area indicating allocation of roles in user units are provided.

### (2) Operations

Operations of the image forming apparatus 2 constituted as described above, in particular, operations concerning role management are explained below.

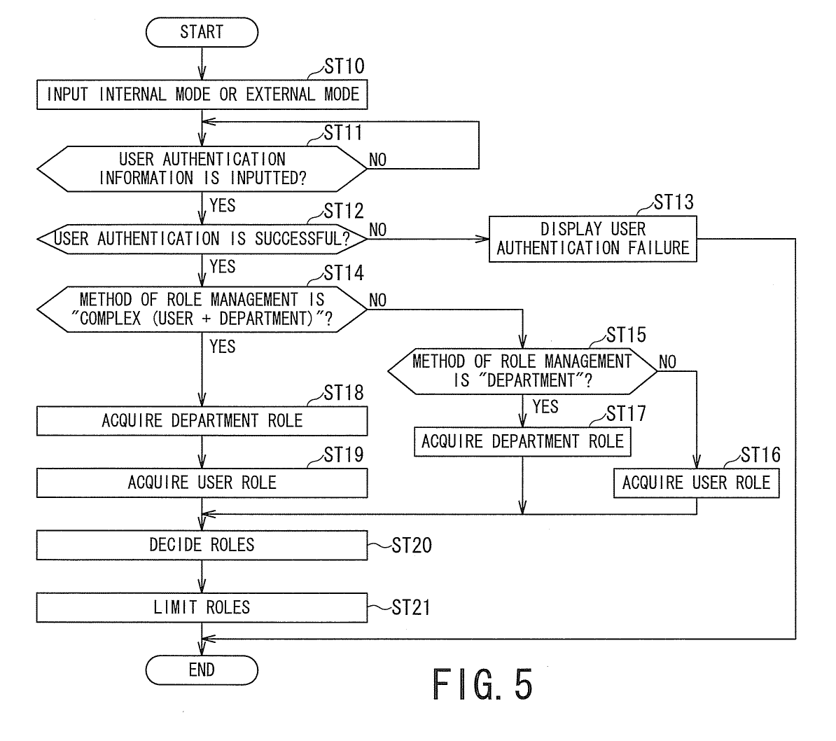

FIG. 5 is a flowchart showing an example of processing concerning role management of the image forming apparatus 2.

First, the image forming apparatus 2 inputs information for identifying the internal mode and the external mode (step ST10). The user selects the internal mode or the external mode. For example, the user sets the internal mode or the external mode from the control panel 25. The image forming apparatus 2 inputs information on this setting. In the case of the internal mode, databases in the image forming apparatus 2 are used as a database for user authentication and role management. In the case of the external mode, databases in the server 3 on the outside of the image forming apparatus 2 are mainly used.

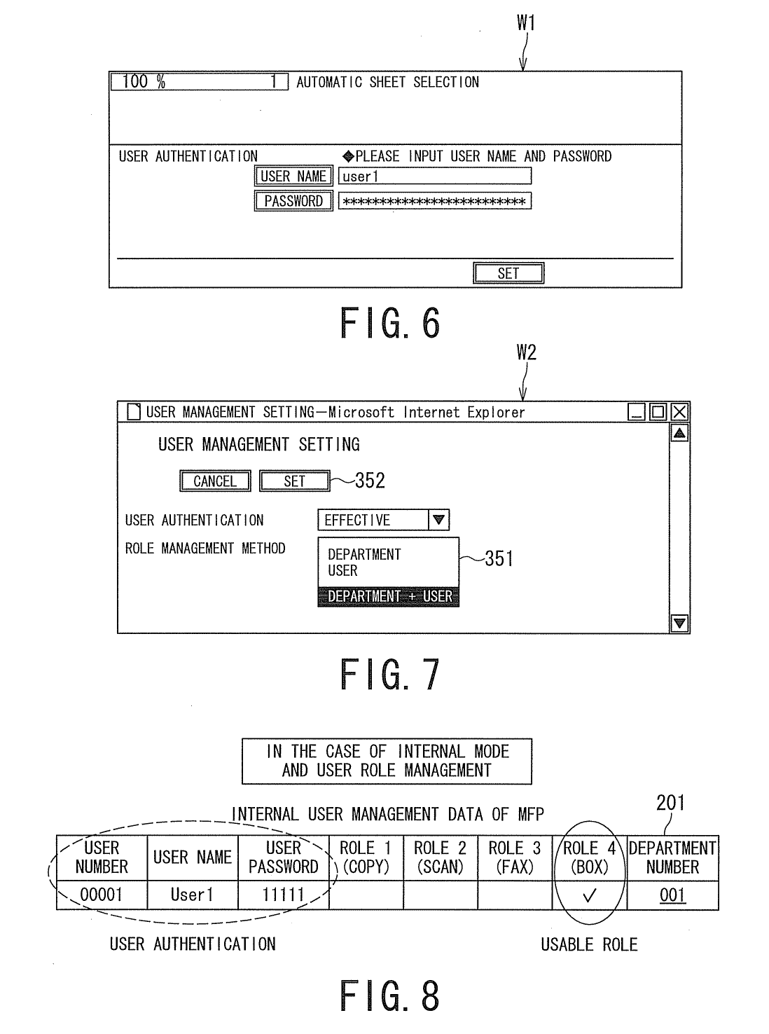

Subsequently, the image forming apparatus 2 waits for an input of authentication information by the user (step ST11). For example, in the case of authentication by a password, the image forming apparatus 2 displays a window W1 illustrated in FIG. 6 on the control panel 25 of the image forming apparatus 2 and urges the user to input a password of the user.

When the password is inputted, the image forming apparatus 2 performs user authentication according to matching between the inputted password and the registered password (step ST12). An authentication database to be referred to is the internal user management data 201 of the image forming apparatus 2 in the case of the internal mode and is the external user management data 301 of the server 3 in the case of the external mode.

In the case of failure in the user authentication, the image forming apparatus 2 displays an indication of authentication failure on, for example, the control panel 25 (step ST13) and finishes the processing.

In the case of success in the user authentication, the image forming apparatus 2 proceeds to processing of role management. In this embodiment, as a method of the role management, there are three types of role management, i.e., user role management for performing role management in user units, department role management for performing role management in department units, and complex (department+user) role management in which the user role management and the department role management are combined.

FIG. 7 is a diagram showing an example of a selection screen W2 for a role management method displayed on the control panel 25. When user authentication is “effective”, three types of methods, “department”, “user”, and “department+user”, are displayed in a selection window 351 for a role management method. The user selects one of the three types of methods and clicks a “set” button 352 to decide a role management method.

In steps ST14 and ST15 in FIG. 5, the image forming apparatus 2 determines a type of the selected role management method. The each role management method will be explained below.

The role management method in user units (No in step ST15) is explained. In this case, the image forming apparatus 2 acquires a role (a user role) allocated in user units from the database (step ST16).

In the case of the internal mode, as shown in FIG. 8, the image forming apparatus 2 refers to the internal user management data 201 of the image forming apparatus 2. The image forming apparatus 2 specifies the authenticated user and acquires a role allocated to the user (in an example in FIG. 8, the role (4)) as a user role.

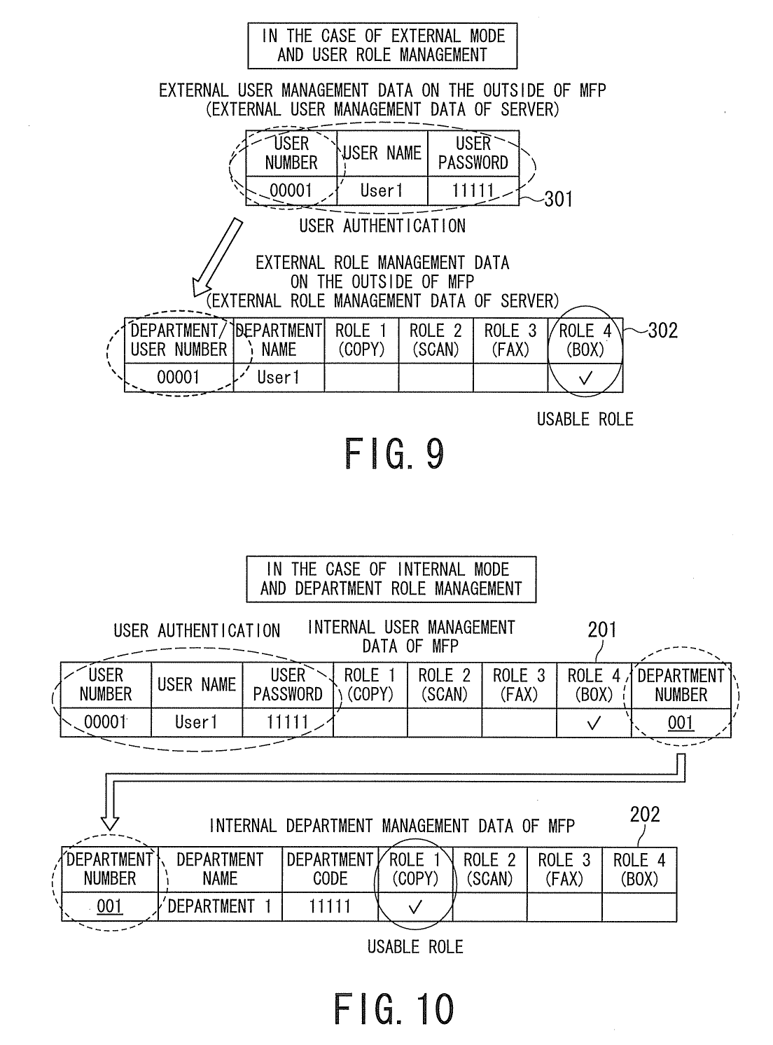

In the case of the external mode, as shown in FIG. 9, first, the image forming apparatus 2 specifies the authenticated user with reference to the external user management data 301 and searches through the external role management data 302 with a user number of the user (in an example in FIG. 9, “00001”) as a key. The image forming apparatus 2 acquires a role allocated to the relevant user number (in the example in FIG. 9, the role (4)) as a user role.

The role management method in department units (YES in step ST15) is explained. In this case, the image forming apparatus 2 acquires a role (a department role) allocated in department units from the database (step ST17).

In the case of the internal mode, as shown in FIG. 10, first, the image forming apparatus 2 specifies the authenticated user with reference to the internal user management data 201. Subsequently, the image forming apparatus 2 specifies a department number of a department to which the user belongs (in an example in FIG. 10, “001”) from the same internal user management data 201. Thereafter, the image forming apparatus 2 searches through the internal department management data 202 with the specified department number as a key and acquires a role allocated to the relevant department number (in the example in FIG. 10, the role (1)) as a department role.

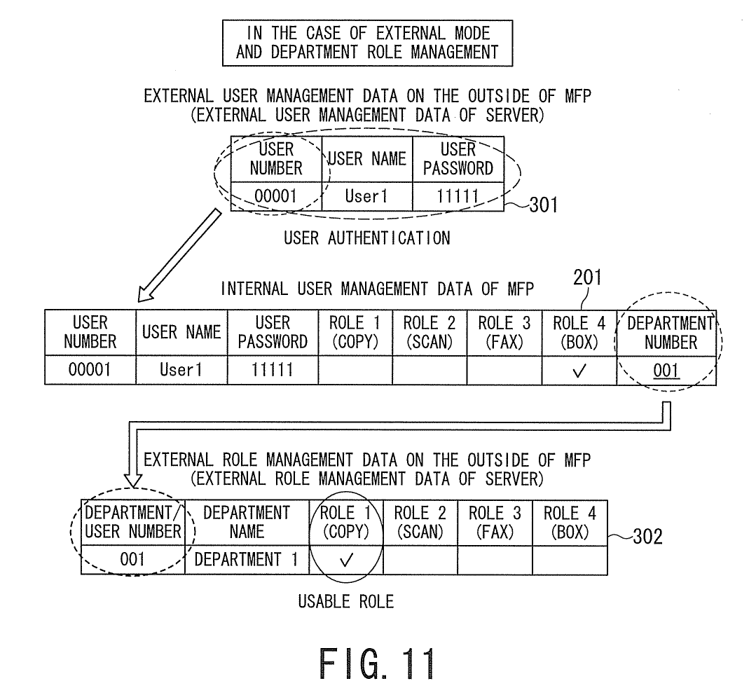

On the other hand, in the case of the external mode, as shown in FIG. 11, first, the image forming apparatus 2 specifies the authenticated user with reference to the external user management data 301. Subsequently, the image forming apparatus 2 specifies, from the specified user, a department to which the user belongs.

As shown in FIG. 4, the database provided in the server 3 is not formed in the structure in which the “user” and the “department” are associated. This is because a database for role management in “department” units is added without substantially changing the structure of the database for role management in “user” units adopted in the past.

Therefore, in the external mode, in specifying a department from a user, the image forming apparatus 2 uses the internal user management data 201 of the image forming apparatus 2 in which the “user” and the “department” are associated. In an example in FIG. 11, from the user number “00001”, the department number “001” of the department to which the user of the user number belongs is specified.

Thereafter, the image forming apparatus 2 accesses the external role management data 302 of the server 3, searches through the external role management data 302 with the specified department number as a key, and acquires a role allocated to the relevant department number (in the example in FIG. 11, the role 1)) as a department role.

When the role management method is “department” or “user”, the acquired department role or user role is directly decided in step ST20.

On the other hand, when-the role management method is “department+user” (the complex role management) (YES in step ST14), the image forming apparatus 2 acquires a department role in step ST18 and acquires a user role in step ST19. Thereafter, in step ST20, the image forming apparatus 2 decides both of the department role and the user role as usable roles.

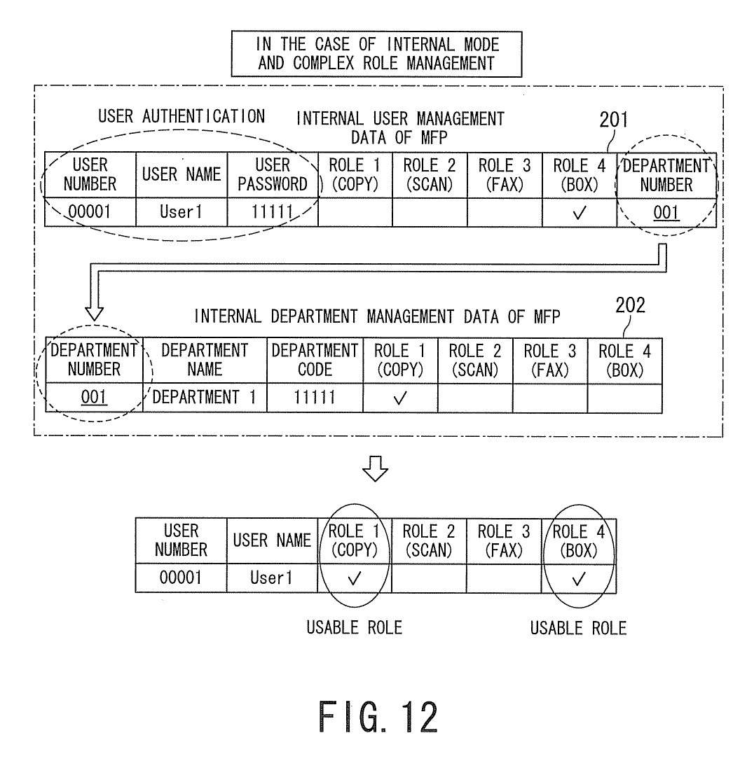

FIG. 12 is a diagram showing a method of acquiring roles in the case of “department+user” (the complex role management) in the internal mode. The image forming apparatus 2 acquires a user role allocated to the authenticated user from the internal user management data 201 (step ST18). Thereafter, the image forming apparatus 2 searches through the internal department management data 202 with a department number of a department to which the user belongs as a key and acquires a role allocated to the relevant department number as a department role (step ST19). The image forming apparatus 2 acquires both the acquired user role and department role and decides the roles (step ST20).

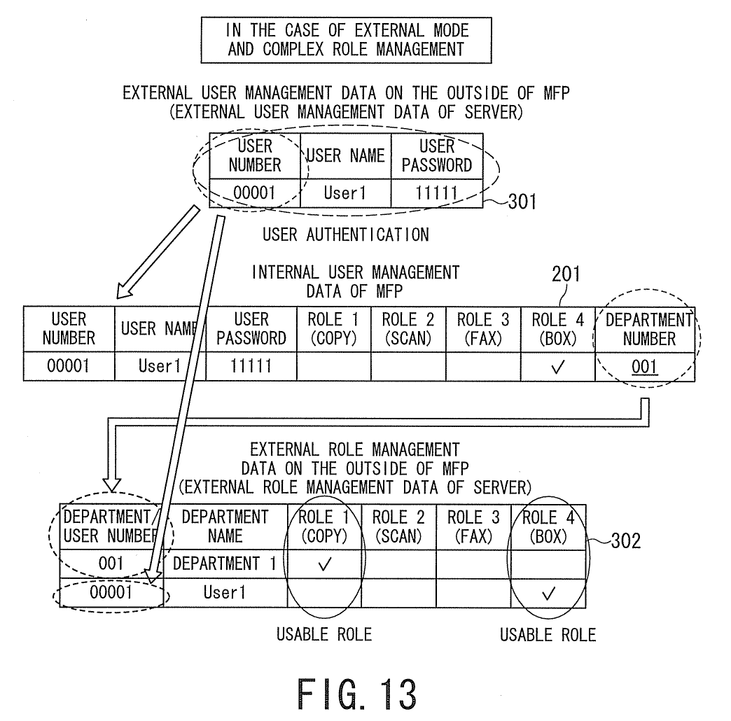

FIG. 13 is a diagram showing a method of acquiring roles in the case of “department+user” (the complex role management) in the external mode. After specifying a user number of the authenticated user from the external user management data 301, the image forming apparatus 2 specifies a department number of a department to which the user belongs with reference to the internal user management data 201. The image forming apparatus 2 searches through the external role management data 302 with the specified user number and department number as keys and acquires a relevant user role and department role (steps ST18 and ST19). Thereafter, the image forming apparatus 2 acquires both the obtained user role and department role and decides the roles (step ST20).

Lastly, the image forming apparatus 2 performs role limitation and sets the image forming apparatus 2 itself such that only the decided roles can be used (step ST21).

As explained above, in the image forming apparatus 2 and the image forming system 1 according to this embodiment, it is possible to easily perform not only the role management in user units but also the role management in department units for a department including plural users when the image forming apparatus is capable of playing plural roles alone.

The present invention is not limited to the embodiment per se. At an implementation stage, elements of the present invention can be modified and embodied without departing from the spirit of the present invention. Various embodiments of the invention can be formed by appropriately combining the plural elements disclosed in the embodiments. For example, several elements may be deleted from all the elements disclosed in the embodiments. Moreover, elements described in the different embodiments may be appropriately combined.

What is claimed is:

1. An image forming apparatus capable of playing plural roles alone, the image forming apparatus comprising:
an authentication database in which association between a user and authentication information of the user is registered;
a role management database in which association between the user and the role allocated to the user, association between a department to which a plurality of the users belong and the role allocated to the department, and association between the user and the department to which the user belongs are registered;
an authenticating unit that performs authentication of the user according to matching between authentication information inputted by the user and the authentication information registered in the authentication database; and
a role managing unit that permits, with reference to the role management database, the user authenticated by the authenticating unit to use the role allocated to the user and permits the department to which the user authenticated by the authenticating unit belongs to use the role allocated to the department.

2. An image forming apparatus according to claim 1, wherein the role managing unit performs role management on the basis of a type of a selected role management method.

3. An image forming apparatus according to claim 2, wherein
the type is any one of user role management, department role management, and complex role management, and
when the user role management is selected, the role managing unit performs role management for permitting the user to use the role allocated to the user,
when the department role management is selected, the role managing unit performs role management for permitting the user to use the role allocated to the department, and
when the complex role management is selected, the role managing unit performs role management for permitting both of the role allocated to the user and the role allocated to the department.

4. An image forming system comprising:
an image forming apparatus capable of playing plural roles alone; and
a server connected to the image forming apparatus through a network, wherein
the server includes:
an external authentication database in which association between a user and authentication information of the user is registered; and
an external role management database in which association between the user and the role allocated to the user and association between a department to which a plurality of the users belong and the role allocated to the department are registered, and
the image forming apparatus includes:
an authenticating unit that performs authentication of the user with reference to the external authentication database; and
a role managing unit that permits, with reference to the external role management database, the user authenticated by the authenticating unit to use the role allocated to the user and permits the department to which the user authenticated by the authenticating unit belongs to use the role allocated to the department.

5. An image forming system according to claim 4, wherein the role managing unit performs role management on the basis of a type of a selected role management method.

6. An image forming system according to claim 5, wherein
the type is any one of user role management, department role management, and complex role management, and
when the user role management is selected, the role managing unit performs role management for permitting the user to use the role allocated to the user,
when the department role management is selected, the role managing unit performs role management for permitting the user to use the role allocated to the department, and
when the complex role management is selected, the role managing unit performs role management for permitting both of the role allocated to the user and the role allocated to the department.

7. An image forming system according to claim 4, wherein
the image forming apparatus further includes:
an internal authentication database in which association between the user and the authentication information of the user is registered;
an internal role management database in which association between the user and the role allocated to the user, association between the department to which the plurality of the users belong and the role allocated to the department, and association between the user and the department to which the user belongs are registered, and
the role managing unit selectably has an external mode and an internal mode,
when the external mode is selected, the role managing unit performs authentication of the user on the basis of the external authentication database and performs role management on the basis of the external role management database, and
when the internal mode is selected, the role managing unit performs authentication of the user on the basis of the internal authentication database and performs role management on the basis of the internal role management database.

8. A control method of an image forming apparatus capable of playing plural roles alone, the control method comprising the steps of:
(a) registering association between a user and authentication information of the user in an authentication database;
(b) registering association between the user and the role allocated to the user, association between a department to which a plurality of the users belong and the role allocated to the department, and association between the user and the department to which the user belongs in a role management database;
(c) performing authentication of the user with reference to the authentication database; and
(d) performing role management for permitting, with reference to the role management database, the authenticated user to use the role allocated to the user and permitting the department to which the authenticated user belongs to use the role allocated to the department.

9. A control method of an image forming apparatus according to claim 8, wherein, in step (d), role management is performed on the basis of a type of a selected role management method.

10. A control method of an image forming apparatus according to claim 9, wherein
the type is any one of user role management, department role management, and complex role management, and
in step (d), when the user role management is selected, role management for permitting the user to use the role allocated to the user is performed, when the department role management is selected, role management for permitting the user to use the role allocated to the department is performed, and, when the complex role management is selected, role management for permitting both of the role allocated to the user and the role allocated to the department is performed.

11. A control method of an image forming apparatus according to claim 8, wherein
the authentication database includes an internal authentication database provided in the image forming apparatus and an external authentication database provided on the outside of the image forming apparatus,
the role management database includes an internal role management database provided in the image forming apparatus and an external role management database provided on the outside of the image forming apparatus,
in step (c), when an external mode is selected, the authentication of the user is performed on the basis of the external authentication database and, when an internal mode is selected, the authentication of the user is performed on the basis of the internal authentication database, and
in step (d), when the external mode is selected, the role management is performed on the basis of the external role management database and, when the internal mode is selected, the role management is performed on the basis of the internal role management database.
